(19) United States
(12) Patent Application Publication
(10) Pub. No.: US 2012/0270022 A1
(43) Pub. Date: Oct. 25, 2012

(54) ADHESIVE-FREE COMPOSITE MADE OF A POLYARYLENE ETHER KETONE FOIL AND OF A METAL FOIL

(75) Inventors: Kirsten ALTING, Muenster (DE); Joerg BLASCHKE, Remscheid (DE)

(73) Assignee: Evonik Degussa GmbH, Essen (DE)

(21) Appl. No.: 13/451,828

(22) Filed: Apr. 20, 2012

(30) Foreign Application Priority Data
Apr. 21, 2011 (DE) 10 2011 007 837.1

(51) Int. Cl. B32B 15/08; B32B 7/02; B29C 65/02

(52) U.S. Cl. 428/216; 156/309.9

(57) ABSTRACT

A process for producing a composite of a polyarylene ether ketone foil a metal foil is provided. The process includes: providing a foil of thickness from 5 to 1200 μm made of a molding composition which comprises: from 60 to 96 parts by weight of polyarylene ether ketone, from 2 to 25 parts by weight of hexagonal boron nitride and from 2 to 25 parts by weight of talc, where the sum of the parts by weight of the components is 100; providing a metal foil of thickness from 10 to 150 μm; and pressing the foils without using an adhesive at a temperature in the range from Tₘ−40K to Tₘ+40K and at a pressure in the range from 4 to 5000 bar. Also provided is the adhesive-free composite foil which is suitable for producing dimensionally stable circuit boards.

### CROSS REFERENCE TO RELATED APPLICATIONS

This application claims priority to German Application No. 102011007837.1, filed Apr. 21, 2011, the disclosure of which is incorporated by reference herein in its entirety.

### BACKGROUND OF THE INVENTION

The invention relates to a composite in which a foil made of a polyarylene ether ketone molding composition has been bonded on one or both sides to a metal foil by an adhesive-free method. The bonding of the foils is achieved through pressing at elevated temperature. The metal foil is applied here per se and not through vacuum deposition methods or electrolytically as conventionally known.

The foils may be used for a wide variety of technical applications, for example as insulation material or as backing of functional layers. In these processes, as a function of requirements, polyarylene ether ketones are mixed with various fillers and optionally further polymers to give compounded materials or to give blends, and these are then further processed to give foils. Foil thicknesses below 10 μm have been achieved. The property profiles place particular emphasis on high resistance to solvents and to temperature change, together with low shrinkage and low expansion, and also high resistance to tear and to tear propagation.

As a function of conduct of the extrusion process, polyarylene ether ketones may be processed to give either amorphous foils or semicrystalline foils. Production of foils with minimum and uniform shrinkage requires maximization of semicrystallinity and minimization of orientation of the polymer molecules. In the extrusion process, the amorphous melt of the polyarylene ether ketone emerges from the die onto what are known as the chill rolls, where complicated process technology is required, with very narrow processing latitude, for conversion to foils with maximum semicrystallinity. However, the process technology of this process makes it very difficult to adjust the orientation of the polymer molecules to give a completely isotropic foil. The result may be therefore a varying shrinkage property profile which occasionally varies greatly across the width of the foil web and can prove problematic or even unacceptable during the further processing and finishing of the foils. It is entirely possible that the shrinkage values within a semicrystalline extruded polyarylene ether ketone foil vary from zero to several per cent, depending on the location of sampling of the foil web for shrinkage measurement. However, specifically for further processing or used in relatively high temperature ranges it is important that the foils have maximum dimensional stability.

The foil which is the object of the present invention is a laminate of polyarylene ether ketone foil with a metal foil. It is a further object to ensure that the required layflat of the laminate is retained in the event of temperature changes during the production process or in the course of continual use. Curl or corrugation of the laminate is not permitted. If the two constituents of the laminate simultaneously have very different coefficients of thermal expansion, the resultant stresses are very different and lead to curl of the laminate, and at the same time may also in turn have a major effect on the adhesion at the interface. This is disadvantageous particularly if the system is subject to high temperature variations in subsequent further processing (for example during soldering processes). To this end, the area coefficients of expansion of the thin polyarylene ether ketone foils and thin metal foils fixed to one another should be almost identical. EP 1 314 760 A1 describes a foil which is intended for use in printed circuits and which can be composed of a polyarylene ether ketone molding composition. The molding composition comprises from 15 to 50% by weight of a “flaky” filler, which for example can be boron nitride. The addition of the filler reduces shrinkage during production, and also reduces thermal expansion, and the foil is therefore intended to be suitable for producing an adhesive-free laminate with a copper foil.

EP 1 234 857 A1 discloses a molding composition for producing foils for flexible circuit boards (FCBs) based for example on polyether ether ketone (PEEK), where addition of a “flaky” filler with certain parameters (preferably mica; talc also being mentioned) has been used to reduce shrinkage and also thermal expansion. Corresponding disclosures based on talc and, respectively, acidic magnesium metasilicate are found in JP 2007-197715A, JP 2003-128943A and JP 2003-128944A. EP 1 234 857 A1 also addresses the production of an adhesive-free laminate with a copper foil.

Finally, JP 2003-128931A describes a molding composition for producing foils for FCBs based on a wide variety of polymers, for example polyarylene ether ketone. The molding composition uses from 5 to 50% by weight of acidic magnesium metasilicate as filler. A number of other fillers including boron nitride may moreover be present. However, there is no explicit disclosure of the combination polyarylene ether ketone/acid magnesium metasilicate/boron nitride. Here again, production of an adhesive-free laminate with a copper foil is addressed.

### SUMMARY OF THE INVENTION

The object of the present invention consists in providing a process which starts with a foil made of a polyarylene ether ketone molding composition which in comparison with conventionally produced foils has lower shrinkage and reduced area coefficient of thermal expansion, and which uses adhesive-free lamination with a metal foil to give a composite with good adhesion and with good layflat.

This and other objects have been achieved by the present invention, the first embodiment of which includes a process for preparing a polyarylene ether ketone foil laminate, the polyarylene ether ketone foil laminate, comprising:

a foil of a polyarylene ether ketone molding composition; and

at least one metal foil having a thickness of from 10 to 150 μm in direct and continuous contact with at least one surface of the polyarylene ether ketone foil;

the process comprising:

providing a foil of the moulding composition having a thickness from 5 to 1200 μm;

providing the metal foil; and

pressing the metal foil directly onto at least one surface of the polyarylene ether ketone foil at a temperature from Tₘ−40K to Tₘ+40K and at a pressure from 4 to 5000 bar; wherein

the molding composition comprises:

a) from 60 to 96 parts by weight of a polyarylene ether ketone,

b) from 2 to 25 parts by weight of hexagonal boron nitride and

c) from 2 to 25 parts by weight of talc,

the sum of the parts by weight of components a), b) and c) is 100; and

Tₘ is the crystallite melting point of the polyarylene ether ketone in the molding composition as determined on the molding composition according to ISO 11357 in a 2nd heating procedure and with a heating and cooling rate of 20K/min. Surprisingly, the inventors have found that simultaneous use of hexagonal boron nitride and talc as filler produces a synergistic effect with regard to shrinkage, layflat performance and tear resistance.

In a second embodiment the present invention includes polyarylene ether ketone foil laminate, comprising: a foil of a polyarylene ether ketone composition having a thickness from 5 to 1200 μm; and at least one metal foil having a thickness of from 10 to 150 μm in direct and continuous contact with at least one surface of the polyarylene ether ketone foil; wherein the polyarylene ether ketone composition comprises:

a) from 60 to 96 parts by weight of a polyarylene ether ketone,

b) from 2 to 25 parts by weight of hexagonal boron nitride and

c) from 2 to 25 parts by weight of talc, and the sum of the parts by weight of components a), b) and c) is 100.

In one preferred embodiment of the present invention, the polyarylene ether ketone of the molding composition is at least one selected from the group consisting of a polyether ether ketone (PEEK), a polyether ketone (PEK), a polyether ketone ketone (PEKK) and a polyether ether ketone ketone (PEEKK).

In another preferred embodiment the present invention provides a polyarylene ether ketone foil laminate, which comprises: a foil of a polyarylene ether ketone molding composition; a metal foil in direct and continuous contact with an upper surface of the polyarylene ether ketone foil; and a metal foil in direct and continuous contact with a lower surface of the polyarylene ether ketone foil; which is made by a process comprising:

providing a foil of the moulding composition having a thickness from 5 to 1200 μm;
providing two metal foils; and pressing one metal foil directly onto the upper surface of the polyarylene ether ketone foil, and the other metal foil directly onto the lower surface of the polyarylene ether ketone foil.

In highly preferred embodiments the metal foil is copper or aluminium. In a further embodiment the present invention includes a flexible circuit board comprising the polyarylene ether ketone foil laminate according to the invention.

### DETAILED DESCRIPTION OF THE PREFERRED EMBODIMENTS OF THE INVENTION

In a first embodiment, the present invention provides a process for preparing a polyarylene ether ketone foil laminate, the polyarylene ether ketone foil laminate, comprising: a foil of a polyarylene ether ketone molding composition; and at least one metal foil having a thickness of from 10 to 150 μm in direct and continuous contact with at least one surface of the polyarylene ether ketone foil. The laminate is made by providing a foil of the moulding composition having a thickness from 5 to 1200 μm; providing the metal foil; and pressing the metal foil directly onto at least one surface of the polyarylene ether ketone foil at a temperature from Tₘ−40K to Tₘ+40K and at a pressure from 4 to 5000 bar; wherein the molding composition comprises:

d) from 60 to 96 parts by weight of a polyarylene ether ketone,

e) from 2 to 25 parts by weight of hexagonal boron nitride and

f) from 2 to 25 parts by weight of talc,

the sum of the parts by weight of components a), b) and c) is 100. Tₘ, is the crystallite melting point of the polyarylene ether ketone in the molding composition as determined on the molding composition according to ISO 11357 in a 2nd heating procedure and with a heating and cooling rate of 20K/min.

The pressure applied may preferably be at least 6 bar, at least 8 bar, at least 10 bar, at least 12 bar or at least 15 bar, and at most 4000 bar, at most 3000 bar, at most 2000 bar, at most 1500 bar, at most 1000 bar or at most 800 bar. These values include all values and subvalues therebetween, and also include combinations of each minimum value with each maximum value.

In a second embodiment the present invention includes polyarylene ether ketone foil laminate, comprising: a foil of a polyarylene ether ketone composition having a thickness from 5 to 1200 μm; and at least one metal foil having a thickness of from 10 to 150 μm in direct and continuous contact with at least one surface of the polyarylene ether ketone foil; wherein the polyarylene ether ketone composition comprises:

g) from 60 to 96 parts by weight of a polyarylene ether ketone,

h) from 2 to 25 parts by weight of hexagonal boron nitride and

i) from 2 to 25 parts by weight of talc, and the sum of the parts by weight of components a), b) and c) is 100.

In a preferred embodiment, the present invention provides a polyarylene ether ketone foil laminate, which comprises: a foil of a polyarylene ether ketone molding composition; a metal foil in direct and continuous contact with an upper surface of the polyarylene ether ketone foil; and a metal foil in direct and continuous contact with a lower surface of the polyarylene ether ketone foil; which is made by a process comprising: providing a foil of the moulding composition having a thickness from 5 to 1200 μm; providing two metal foils; and pressing one metal foil directly onto the upper surface of the polyarylene ether ketone foil, and the other metal foil directly onto the lower surface of the polyarylene ether ketone foil.

Individual pieces of the foils as described above, optionally together with release foils and balancing foils, may be stacked on top of each other and pressed in a lamination press under vacuum using pressure to give a laminate metal-coated on one or both sides. As an alternative to this, roll-to-roll pressing may be conducted in a suitable press to give continuous laminate.

The polyarylene ether ketone (PAEK) comprises units of the formulae

(—Ar—X—) and (—Ar′—Y—),

where Ar and Ar′ are each a divalent aromatic moiety, preferably 1,4-phenylene, 4,4′-biphenylene, or else 1,4-, 1,5- or 2,6-naphthylene. X is an electron-withdrawing group, preferably carbonyl or sulphonyl, while Y is another group such as O, S, CH₂, isopropylidene or the like. At least 50% of the groups X here, preferably at least 70% and particularly preferably at least 80%, may be a carbonyl group, while at least 50% of the groups Y, preferably at least 70%, and particularly preferably at least 80%, may be oxygen.

In a highly preferred embodiment of the present invention, 100% of the groups X may be carbonyl groups and 100% of the groups Y may be oxygen. In this embodiment, the PAEK may, for example be a polyether ether ketone (PEEK; formula I), a polyether ketone (PEK; formula II), a polyether ketone ketone (PEKK; formula III) or a polyether ether ketone ketone (PEEKK; formula IV), but other arrangements of the carbonyl groups and of the oxygen groups are naturally also possible.

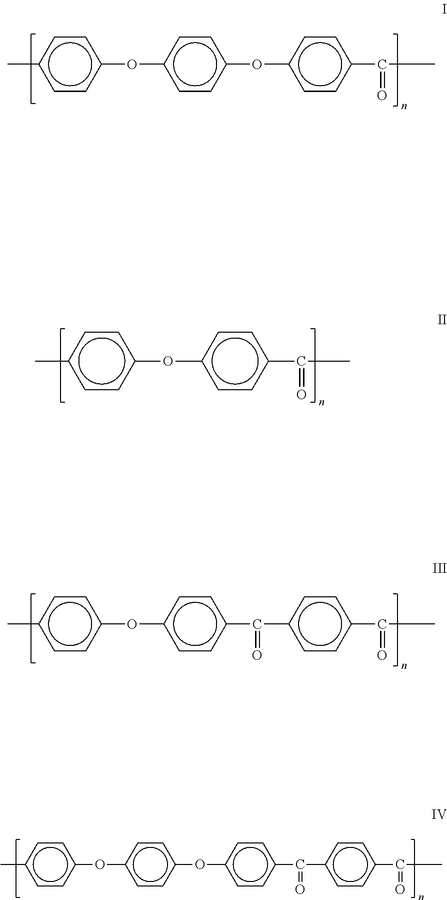

The PAEK may be semicrystalline, as determined by DSC analysis through observation of a crystallite melting point Tₘ which in most instances is of the order of magnitude of 300° C. or thereabove. As a general rule, crystallinity may be reduced by sulphonyl groups, biphenylene groups, naphthylene groups, or bulky groups Y, e.g. an isopropylidene group.

In one preferred embodiment, the viscosity of the polyarylene ether ketone is about 20 to 150 cm³/g, and preferably from 50 to 120 cm³/g as measured according to DIN EN ISO 307 on a solution of 250 mg of PAEK in 50 ml of 96 percent by weight H₂SO₄ at 25° C.

The PAEK may be produced by a conventionally known nucleophilic route through polycondensation of bisphenols and of organic dihalogen compounds and/or of halophenols in a suitable solvent in the presence of an auxiliary base; the process is described for example in EP-A-0 001 879, EP-A-0 182 648 and EP-A-0 244 167.

Alternatively, the PAEK may also be produced by a conventionally known electrophilic route in a medium which is strongly acidic or which comprises a high concentration of Lewis acid; this process is described for example in EP-A-1 170 318 and in the literature cited therein.

Hexagonal boron nitride is composed of layers of a planar, hexagonal honeycomb structure in which the B atoms and N atoms respectively occur in alternation. It may thus be comparable with graphite; the physical properties of hexagonal boron nitride and graphite are very similar. However, unlike graphite, hexagonal boron nitride does not conduct electrical current until very high temperatures are reached. Various types of hexagonal boron nitride are commercially available.

In one preferred embodiment, the d₅₀ particle size of the hexagonal boron nitride may be at least 0.1 μm, at least 0.2 μm, at least 0.3 μm or at least 0.4 μm, and at most 10 μm, at most 8 μm, at most 6 μm, at most 5 μm, at most 4 μm, at most 3 μm, or at most 2 μm. The d₉₈ particle size may correspondingly be at least 0.3 μm, at least 0.6 μm, at least 0.7 μm or at least 0.8 μm, and at most 20 μm, at most 16 μm, at most 12 μm, at most 10 μm, at most 8 μm, at most 6 μm or at most 4 μm. These values include all values and subvalues therebetween, and also include combinations of each minimum value with each maximum value.

The particle size may be measured by laser diffraction according to ISO 13320, for example using a Mastersizer 2000 from Malvern Instruments GmbH.

Talc is a naturally occurring mineral having a chemical constitution of the formula: Mg₃Si₄O₁₀(OH)₂. It is a crystalline magnesium silicate hydrate, belonging to the family of the phyllosilicates. Talc is described in more detail in Kirk-Othmer, Encyclopedia of Chemical Technology, 4th Edition, Vol. 23, John Wiley & Sons 1997, pp. 607 to 616.

In one preferred embodiment, the d₅₀ particle size of the talc is at least 0.1 μm, at least 0.2 μm, at least 0.3 μm or at least 0.4 μm, and at most 10 μm, at most 8 μm, at most 6 μm, at most 5 μm, at most 4 μm, at most 3 μm or at most 2 μm. The d₉₈ particle size is correspondingly at least 0.3 μm, at least 0.6 μm, at least 0.7 μm or at least 0.8 μm and at most 20 μm, at most 16 μm, at most 12 μm, at most 10 μm, at most 8 μm, at most 6 μm or at most 4 μm. These values include all values and subvalues therebetween, and also include combinations of each minimum value with each maximum value.

The particle size may be determined according to ISO 13317, Part 3 (X-ray Gravitational Technique) for example using a Sedigraph 5120 from Micromeritics Instrument Corporation.

The polyarylene ether ketone moulding composition may optionally comprise further components, for example processing aids, stabilizers, or flame retardants. The type and amount are to be selected in such a way as to avoid any substantial impairment of the effect of the invention. It may also be possible to add silanes and/or oligomeric siloxanes, for example in proportions of from 0.5 to 2.5% by weight and preferably from 1 to 2% by weight, based on the entire formulation, in order to improve coupling of the fillers and in order to improve resistance to tear.

The polyarylene ether ketone foil may be prepared by a process comprising:

a)in a compounding operation, mixing hexagonal boron nitride and talc with a polyarylene ether ketone melt, in the proportions as described above to prepare a molding composition melt;
b)in an extrusion operation, extruding the melt of the molding composition in a slot die;
c)in a solidification stage, laying the drawn-off extruded foil web on chill rolls and cooling to obtain the polyarylene ether ketone foil.

In the compounding operation, the melt may be discharged, cooled and pelletized. The pellets may then be remelted with shear in the extruder, in the extrusion operation. However, it is also possible to operate in one stage, where the extrusion follows the compounding directly in the same machine. This method avoids pelletization, and thus reduces cost; it may also achieve better foil quality.

In the course of the compounding or extrusion, the melt of the molding composition may, optionally, be filtered, in order to remove specks.

Edge trim and wind-up may be performed in a subsequent finishing operation in a winder unit.

In the event that the adhesion is inadequate for the selected application, the foil made of the polyarylene ether ketone moulding composition may also be subjected to surface treatment, for example corona treatment or plasma treatment.

The metal may be copper, aluminum or other metal. Preferably the metal is copper.

Surprisingly, it has been found that simultaneous use of hexagonal boron nitride and talc as filler produces a synergistic effect. The total amount of filler that has to be added in order to achieve the desired effect is therefore smaller. It is therefore possible to produce foils which may be used according to the invention and which have improved mechanical properties, for example having improved resistance to tear and to tear propagation.

The foil composite produced according to the invention may be especially useful for circuit boards and in particularly preferred embodiment, for flexible circuit boards. The thickness of the PAEK foil layer for utility as a flexible circuit board is preferably from 6 to 150 μm, particularly preferably from 12 to 125 μm, with particular preference from 18 to 100 μm and very particularly preferably from 25 to 75 μm.

When flexible circuit boards are produced, the conductor pattern may be printed onto the metal layer or applied by photolithographic methods. The etching and stripping process may then be used to produce the conductor pattern. The procedure may then differ greatly, depending on the application. Examples of further conventionally known operations are drilling, stamping, surface finishing, use of electroplating for vias, production of multilayer systems in vacuum presses, lamination of outer foils using pressure and heat, printing of insulating coat or of solder resist, various soldering processes (e.g. solder paste printing or provision of components) and provision of contacting parts through crimping, piercing or other mechanical processes.

The foils according to the invention may achieve isotropic dimensional stability of a foil, i.e. both longitudinal stability and transverse stability, involving less than 0.1% dimensional change at temperatures up to 260° C. In order to simulate the conditions during production of an FCB, measurements are made on a foil specimen of dimensions 20×20 cm, and specifically prior to and after 5 minutes of exposure to a temperature of 260° C. To this end, the shrinkage of the sheet of foil specimen is determined over 2 lengths and 2 widths, at a total of 8 measurement points. The intention here is to replicate the maximum temperature to which the foil may be exposed under solder bath conditions, by allowing a generously long exposure time, which in this case is more than five times the soldering times that occur in conventional soldering processes with exposure to a maximum temperature of 260° C. This may ensure that the foil does not enter its region of borderline stability, and that the maximum longitudinal and transverse shrinkage of 0.1% after soldering is never exceeded.

Having generally described this invention, a further understanding can be obtained by reference to certain specific examples which are provided herein for purposes of illustration only, and are not intended to be limiting unless otherwise specified.

### EXAMPLES

### Compounding

The materials PEEK, boron nitride (BN) and talc were mixed and pelletized in a Coperion (ZSK 26) plant with a corotating twin screw. The fillers were added by way of the first intake; however, the addition could also have been conducted by way of sidefeeders. The processing temperature was about 370° C., and throughput was from 8 to 10 kg/h.

### Foil Production

Foils of thickness 50 μm and width 360 mm were then produced on a Dr. Collin foil extrusion plant using a three-zone screw and the following process parameters: processing temperature about 370° C., throughput about 2 to 3 kg/h, take-off speed 5 m/min, roll temperatures: from 180 to 250° C.

### Composite Production

The foil was processed from roll to roll with an electrolytically produced copper foil (thickness 50 μm; width 360 mm) to give laminate. Maximum process temperature during the lamination process was 335° C.; the pressure used for the pressing process was 40 bar. The take-off speed used was 2 m/min. Strips were punched out of the laminate, and adhesion was measured on these by means of a peel test. Susceptibility to curl was also determined on sections of laminate of length 300 mm, by placing the laminate on a flat surface with the copper side upwards. Table 1 gives the results.

TABLE 1
Experiments

| | | | | Adhesion, | |
|---|---|---|---|---|---|
| | | | | punched | |
| | Constitution of | | | longitudinally | Susceptibility of |
| | PEEK foil [parts by | | | (centre) | laminate to curl |
| Example | weight] | Tₘ | Comment | [N/mm] | (mm) |
| 1 | 70 of PEEK | 339° C. | Cu smooth | 1.7 | 0 (flat) |
| | 15 of boron nitride | | side | | |
| | 15 of talc | | | | |
| 2 | 70 of PEEK | 339° C. | Cu rough | 1.8 | 0 (flat) |
| | 15 of boron nitride | | side | | |
| | 15 of talc | | | | |
| 3^{a)} | 100 of PEEK | 336° C. | Cu rough | 0.04 | lack of adhesion |
| | 0 of boron nitride | | side | | prevented |
| | 0 of talc | | | | determination; on |
| | | | | | adhesive-bonded |
| | | | | | laminate for |
| | | | | | comparison: 50 |

^{a)}not according to the invention

What is claimed is:

1. A process for preparing a polyarylene ether ketone foil laminate, the polyarylene ether ketone foil laminate, comprising:
a foil of a polyarylene ether ketone molding composition; and
at least one metal foil having a thickness of from 10 to 150 μm in direct and continuous contact with at least one surface of the polyarylene ether ketone foil;
the process comprising:
providing a foil of the moulding composition having a thickness from 5 to 1200 μm;
providing the metal foil; and
pressing the metal foil directly onto at least one surface of the polyarylene ether ketone foil at a temperature from Tₘ−40K to Tₘ+40K and at a pressure from 4 to 5000 bar;
wherein
the molding composition comprises:
j) from 60 to 96 parts by weight of a polyarylene ether ketone,
k) from 2 to 25 parts by weight of hexagonal boron nitride and
l) from 2 to 25 parts by weight of talc,
the sum of the parts by weight of components a), b) and c) is 100; and
Tₘ is the crystallite melting point of the polyarylene ether ketone in the molding composition as determined on the molding composition according to ISO 11357 in a 2nd heating procedure and with a heating and cooling rate of 20K/min.

2. The process according to claim 1, wherein
the thickness of the polyarylene ether ketone foil is from 8 to 600 μm.

3. The process according to claim 1, wherein
the thickness of the metal foil is from 17 to 105 μm.

4. The process according to claim 1, wherein
the polyarylene ether ketone is at least one selected from the group consisting of a polyether ether ketone (PEEK), a polyether ketone (PEK), a polyether ketone ketone (PEKK) and a polyether ether ketone ketone (PEEKK).

5. The process according to claim 1, wherein the viscosity of the polyarylene ether ketone is about 20 to 150 cm³/g, as measured according to DIN EN ISO 307 on a solution of 250 mg of PAEK in 50 ml of 96 per cent by weight H₂SO₄ at 25° C.

6. The process according to claim 1, wherein
a d₅₀ particle size of the boron nitride is at least 0.1 μm and at most 10 μm, and
a corresponding d₉₈ particle size of the boron nitride is at least 0.3 μm and at most 20 μm,
as determined according to ISO 13320.

7. The process according to claim 1, wherein
a d₅₀ particle size of the talc is at least 0.1 μm and at most 10 μm, and
a corresponding d₉₈ particle size is at least 0.3 μm and at most 20 μm,
as determined according to ISO 13317, Part 3.

8. The process according to claim 1, wherein
the molding composition further comprises at least one selected from the group consisting of a processing aid, a stabilizer, and a flame retardant.

9. The process according to claim 1, wherein
the molding composition further comprises a silane, an oligomeric siloxane or a mixture thereof.

10. The process according to claim 1, wherein
the polyarylene ether ketone foil laminate comprises:
a foil of a polyarylene ether ketone molding composition;
a metal foil in direct and continuous contact with an upper surface of the polyarylene ether ketone foil; and
a metal foil in direct and continuous contact with a lower surface of the polyarylene ether ketone foil;
the process comprising:
providing a foil of the moulding composition having a thickness from 5 to 1200 μm;
providing two metal foils; and
pressing one metal foil directly onto the upper surface of the polyarylene ether ketone foil, and
the other metal foil directly onto the lower surface of the polyarylene ether ketone foil.

11. The process according to claim 1, wherein
the metal foil is copper or aluminium.

12. A polyarylene ether ketone foil laminate, comprising:
a foil of a polyarylene ether ketone composition having a thickness from 5 to 1200 μm; and
at least one metal foil having a thickness of from 10 to 150 μm in direct and continuous contact with at least one surface of the polyarylene ether ketone foil;
wherein
the polyarylene ether ketone composition comprises:
m) from 60 to 96 parts by weight of a polyarylene ether ketone,
n) from 2 to 25 parts by weight of hexagonal boron nitride and
o) from 2 to 25 parts by weight of talc, and
the sum of the parts by weight of components a), b) and c) is 100.

13. The polyarylene ether ketone foil laminate according to claim 12, wherein a dimensional change of the polyarylene ether ketone foil at temperatures up to 260° C. is less than 0.1%.

14. The polyarylene ether ketone foil laminate according to claim 12, wherein the foil comprises:
a metal foil in direct and continuous contact with an upper surface of the polyarylene ether ketone foil; and
a metal foil in direct and continuous contact with a lower surface of the polyarylene ether ketone foil.

15. The polyarylene ether ketone foil laminate according to claim 12, wherein the polyarylene ether ketone is at least one selected from the group consisting of a polyether ether ketone (PEEK), a polyether ketone (PEK), a polyether ketone ketone (PEKK) and a polyether ether ketone ketone (PEEKK).

16. The polyarylene ether ketone foil laminate according to claim 12, wherein a d₅₀ particle size of the boron nitride is at least 0.1 μm and at most 10 μm, and
a corresponding d₉₈ particle size of the boron nitride is at least 0.3 μm and at most 20 μm,
as determined according to ISO 13320.

17. The polyarylene ether ketone foil laminate according to claim 12, wherein a d₅₀ particle size of the talc is at least 0.1 μm and at most 10 μm, and
a corresponding d₉₈ particle size is at least 0.3 μm and at most 20 μm,
as determined according to ISO 13317, Part 3.

18. A flexible circuit board comprising the polyarylene ether ketone foil laminate according to claim 12.

19. The flexible circuit board according to claim 18, wherein
the thickness of the polyarylene ether ketone foil is from 6 to 150 μm.

20. A flexible circuit board comprising the polyarylene ether ketone foil laminate according to claim 13.
